(19) United States
(12) Patent Application Publication
(10) Pub. No.: US 2026/0348196 A1
(43) Pub. Date: Nov. 5, 2026

(54) LOCK STRUCTURE WITH REPLACEABLE LOCK CORE

(71) Applicant: REAL LOCKS & SECURITY CO., LTD., New Taipei City (TW)

(72) Inventor: Hsi-Hao HO, New Taipei City (TW)

(21) Appl. No.: 19/558,798

(22) Filed: Mar. 6, 2026

(30) Foreign Application Priority Data
May 2, 2025 (TW) 114116648

(51) Int. Cl. E05B 63/00; E05B 1/00; E05B 9/04

(52) U.S. Cl. CPC E05B 63/0056; E05B 1/0007; E05B 2009/046

(57) ABSTRACT

A lock structure includes a shell, a knob, a lock core, a positioning block, and a latch tongue. The shell includes a housing and a cover. The housing includes a lock cylinder. The knob is coupled to the cover. The knob extends into the cover and includes a latch block. The lock core includes a locking section, a coupling section, and a connecting section disposed between the locking section and the coupling section. The locking section extends into the lock cylinder and detachably engages with the latch block. The coupling section protrudes from the lock cylinder. The positioning block is mounted on the connecting section and is detachably secured within the lock cylinder. The latch tongue is detachably coupled to the coupling section.

### BACKGROUND OF THE DISCLOSURE

### Technical Field

The technical field relates to a lock structure, and particularly to a lock structure with a replaceable lock core.

### Description of Related Art

A mechanical lockset commonly available on the market generally adopts a fixed-type design of a lock core. In such a lockset, the lock core is permanently assembled with the lock housing during manufacturing. Once the lock core wears, malfunctions, or is damaged due to improper operation, it is often impossible to disassemble the lock core for repair or replacement.

To restore the functionality of the lockset, it is typically necessary to replace the entire lockset, which leads to resource waste and an additional economic burden.

Although some lock designs of the related art provide replaceable lock core functionality, such designs often involve complex structures and require special tools or professional knowledge for installation and disassembly. This makes it difficult for users to operate independently. Moreover, these designs may suffer from reliability issues, such as insecure fixation of the lock core, loosening during use, or vulnerability to disassembly.

In view of the various inconveniences and security concerns associated with the replaceable lock cores of the related art, the applicant proposes this disclosure to provide a lock design that simplifies the structure, allows for quick installation, and enables users to easily replace the lock cylinder, which is the objective of the applicant's research and development.

### SUMMARY OF THE DISCLOSURE

One objective of this disclosure is to provide a lock structure with a replaceable lock core, which simplifies structures, allows for quick installation, facilitates easy replacement of the lock core, and enhances usability and convenience.

This disclosure is a lock structure including a shell, a knob, a lock core, a positioning block, and a latch tongue. The shell includes a housing and a cover attached to the housing. The housing includes a lock cylinder. The knob extends into and is coupled to the cover. The knob includes a latch block located on an end thereof. The lock core includes a locking section, a coupling section, and a connecting section disposed between the locking section and the coupling section. The locking section extends into the lock cylinder and is configured to detachably engage with the latch block, and the coupling section protrudes from the lock cylinder. The positioning block is mounted on the connecting section and is detachably secured within the lock cylinder. The latch tongue is detachably coupled to the coupling section.

In one embodiment of this disclosure, an engaging slot is defined on an end surface of the locking section, and the locking section is positioned through the latch block engaging with the engaging slot.

In one embodiment of this disclosure, the lock structure further includes a restricting plate located between the positioning block and the latch tongue. The restricting plate is detachably coupled to the coupling section.

In one embodiment of this disclosure, the lock cylinder includes a restricting surface formed on an end away from the cover, and the restricting plate rotates with the lock core and is selectively abutted against the restricting surface.

In one embodiment of this disclosure, the end surface of the positioning block is flush with the end surface of the lock cylinder to form a rotation space on one side of the restricting surface.

In one embodiment of this disclosure, the coupling section includes a restricting block. A restricting hole is defined on the restricting plate, and the restricting plate is positioned on the coupling section by being mounted on the restricting block via the restricting hole.

In one embodiment of this disclosure, the lock structure further includes a nut, wherein the coupling section includes a plurality of first threads, and the latch tongue is fixed to the coupling section by the nut screwing with the first threads.

In one embodiment of this disclosure, the positioning block includes a plurality of second threads on the periphery thereof; the lock cylinder includes a plurality of internal threads on the inner wall surface thereof; and the positioning block is secured within the lock cylinder by threaded engagement between the second threads and the internal threads.

In one embodiment of this disclosure, a through hole is defined on the positioning block, and the positioning block is mounted on the connecting section via the through hole.

In one embodiment of this disclosure, a plurality of latching grooves is defined on the positioning block.

In comparison with the related art, the lock structure of this disclosure includes a shell, a knob, a lock core, a positioning block, and a latch tongue. The knob includes a latch block for engaging the lock core, while the lock core and the positioning block are positioned within the lock cylinder of the shell. To replace the lock core, the positioning block is first detached from the lock core, allowing the lock core to be moved from the lock cylinder. A new lock core may then be inserted into the lock cylinder, and the positioning block is assembled to secure the lock core, thereby completing the replacement of the lock core. Furthermore, the lock structure of this disclosure is simplified and quick to install, and users may replace the lock core easily, thereby improving the performance and convenience of use.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIGS. 1 and 2 depict perspective schematic views from two sides of the lock structure with a replaceable lock core of this disclosure.

FIG. 3 depicts a perspective exploded view of the lock structure with a replaceable lock core of this disclosure.

FIG. 4 depicts a schematic view showing the positioning block being separated from the lock cylinder of the lock structure with a replaceable lock core of this disclosure.

FIG. 5 is a schematic view showing the lock core being separated from the lock cylinder of the lock structure with a replaceable lock core of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

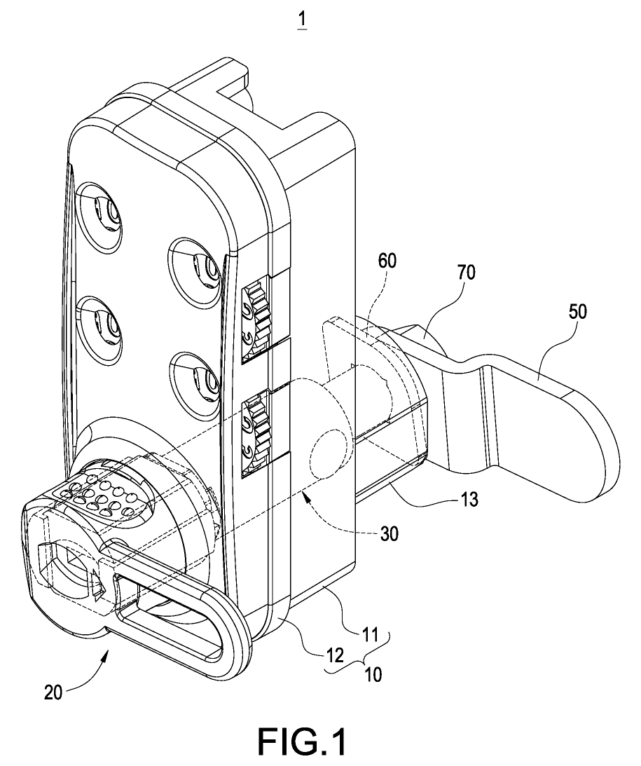

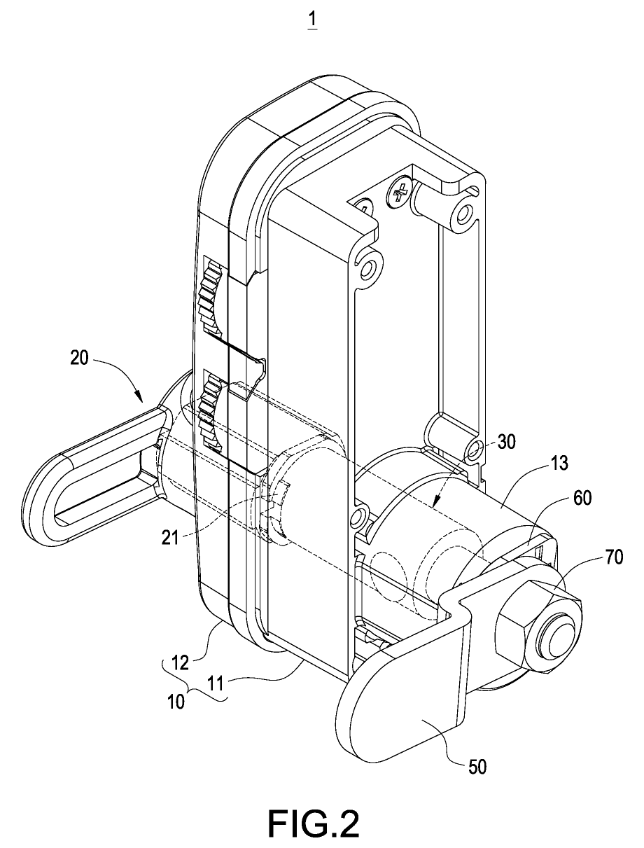

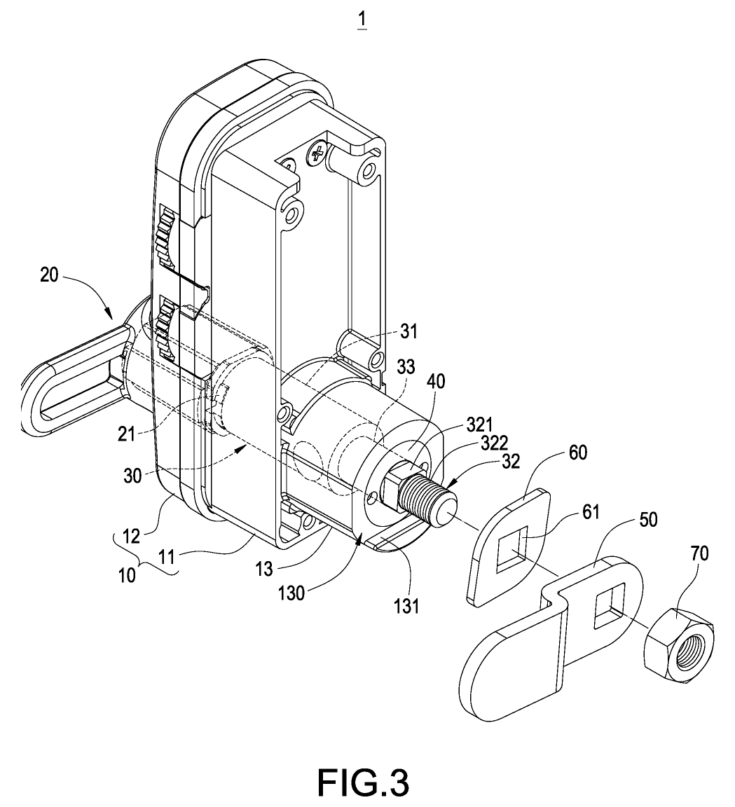

With reference to FIGS. 1-3, FIGS. 1 and 2 depict perspective schematic views from two sides of the lock structure with a replaceable lock core of this disclosure, and FIG. 3 depicts a perspective exploded view of the lock structure with a replaceable lock core of this disclosure. The lock structure 1 includes a shell 10, a knob 20, a lock core 30, a positioning block 40, and a latch tongue 50. The shell 10 includes a housing 11 and a cover 12 attached to the housing 11. The housing 11 includes a lock cylinder 13. The knob 20 extends into and is coupled to the cover 12. The knob 20 includes a latch block 21 located on the end thereof. Additionally, the lock core 30 and the positioning block 40 are positioned in the lock cylinder 13. The latch tongue 50 is coupled to one end of the lock core 30. More details of the lock structure 1 are described as follows.

Specifically, the lock core 30 includes a locking section 31, a coupling section 32, and a connecting section 33 disposed between the locking section 31 and the coupling section 32. The locking section 31 extends into the lock cylinder 13 and detachably engages with the latch block 21. The coupling section 32 protrudes from the lock cylinder 13. Additionally, the positioning block 40 is mounted on the connecting section 33 and is detachably secured within the lock cylinder 13. The latch tongue 50 is detachably coupled to the coupling section 32.

In this embodiment, the lock structure 1 of this disclosure further includes a restricting plate 60 and a nut 70. The restricting plate 60 is configured to limit the rotational direction of the lock core 30. The restricting plate 60 is disposed between the positioning block 40 and the latch tongue 50 and is detachably coupled to the coupling section 32. The coupling section 32 of the lock core 30 includes a restricting block 321. A restricting hole 61 is defined on the restricting plate 60, and the restricting plate 60 is positioned on the coupling section 32 by being mounted on the restricting block 321 via the restricting hole 61. Additionally, the lock cylinder 13 includes a restricting surface 131 formed on the end away from the cover 12. The restricting plate 60 rotates with the lock core 30 and is selectively abutted against the restricting surface 131.

It is noted that the end surface of the positioning block 40 is flush with the end surface of the lock cylinder 13, thereby forming a rotation space 130 on one side of the restricting surface 131. The restricting plate 60 is rotatable within the rotation space 130 to abut against the restricting surface 131. Additionally, the coupling section 32 of the lock core 30 includes a plurality of first threads 322. The latch tongue 50 is fixed to the coupling section 32 by being threadedly engaged with the first threads 322 via the nut 70.

To replace the lock core 30 of the lock structure 1, the nut 70, the latch tongue 50, and the restricting plate 60 must first be sequentially detached from the coupling section 32 of the lock core 30. Then, the positioning block 40 is detached from the connecting section 33 of the lock core 30. Finally, the lock core 30 may be moved from the lock cylinder 13.

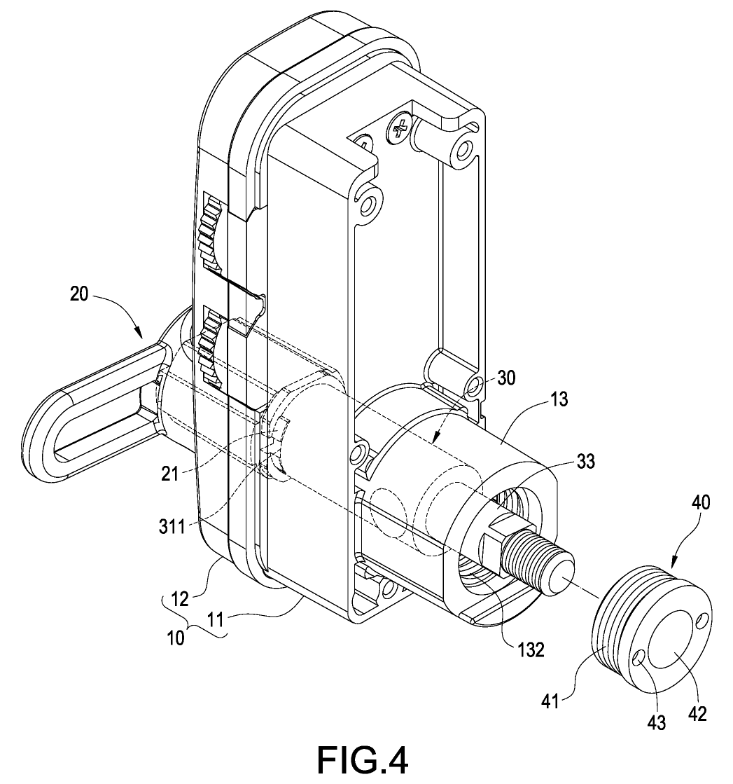

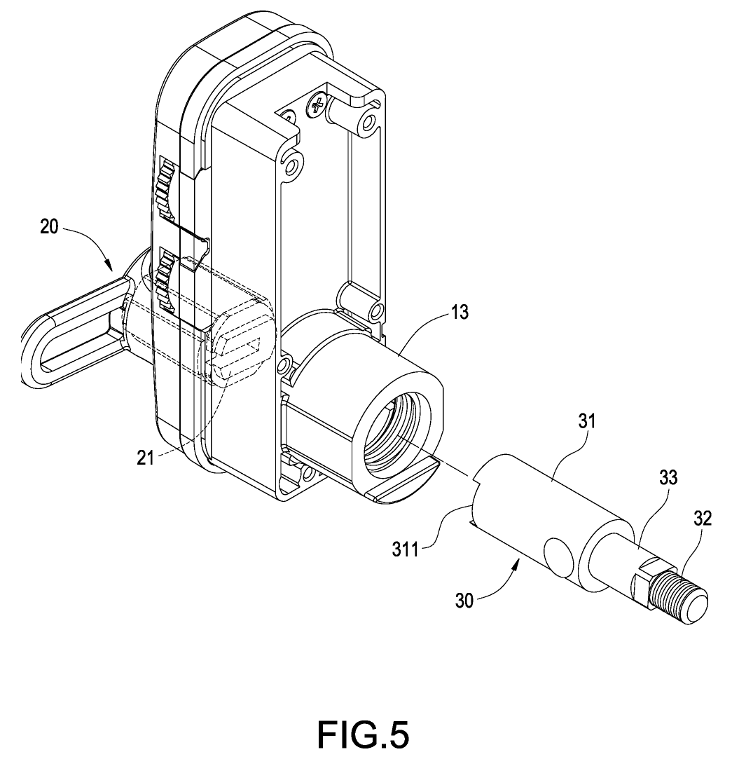

Please refer to FIGS. 4, and 5, which depict a schematic view showing the positioning block being separated from the lock cylinder of the lock structure of this disclosure and a schematic view showing the lock core being separated from the lock cylinder of the lock structure of this disclosure. The positioning block 40 of the lock structure 1 includes a plurality of second threads 41 on its periphery. Moreover, the lock cylinder 13 includes a plurality of internal threads 132 on its inner wall surface. In this embodiment, a through hole 42 is defined on the positioning block 40, and the positioning block 40 is mounted on the connecting section 33 via the through hole 42. The positioning block 40 is then secured within the lock cylinder 13 by threaded engagement between the second threads 41 and the internal threads 132. It is worth noting that a plurality of latching grooves 43 are defined on the positioning block 40. These latching grooves 43 are designed for inserting a tool to facilitate applying torque to rotate the positioning block 40 and move it from the lock cylinder 13.

Furthermore, the positioning block 40 of the lock structure 1 is first moved from the lock cylinder 13, and the lock core 30 is disengaged from the latch block 21 of the knob 20 to allow the lock core 30 to be removed from the lock cylinder 13. Subsequently, a new lock core 30 is inserted into the lock cylinder 13, followed by the sequential assembly of the positioning block 40, the restricting plate 60, the latch tongue 50, and the nut 70, thereby completing the replacement of the lock core 30 in the lock structure 1.

It should be noted that the knob 20 extends into the cover 12 and includes a latch block 21 on the end thereof. Additionally, an engaging slot 311 is defined on the end surface of the locking section 31. The locking section 31 is positioned through the latch block 21 engaging with the engaging slot 311. When the engaging slot 311 is disengaged from the latch block 21, the lock core 30 may be moved from the lock cylinder 13.

While this disclosure has been described by means of specific embodiments, numerous modifications and variations may be made thereto by those skilled in the art without departing from the scope and spirit of this disclosure set forth in the claims.

What is claimed is:

1. A lock structure, comprising:
a shell, comprising a housing and a cover attached to the housing, the housing comprising a lock cylinder;
a knob, extending into and coupled to the cover, comprising a latch block located on an end thereof;
a lock core, comprising a locking section, a coupling section, and a connecting section disposed between the locking section and the coupling section, wherein the locking section extends into the lock cylinder and is configured to detachably engage with the latch block, and the coupling section protrudes from the lock cylinder;
a positioning block, mounted on the connecting section and detachably secured within the lock cylinder; and
a latch tongue, detachably coupled to the coupling section.

2. The lock structure according to claim 1, wherein an engaging slot is defined on an end surface of the locking section, and the locking section is positioned through the latch block engaging with the engaging slot.

3. The lock structure according to claim 1, further comprising a restricting plate located between the positioning block and the latch tongue, wherein the restricting plate is detachably coupled to the coupling section.

4. The lock structure according to claim 3, wherein the lock cylinder comprises a restricting surface formed on an end away from the cover, and the restricting plate rotates with the lock core and is selectively abutted against the restricting surface.

5. The lock structure according to claim 4, wherein an end surface of the positioning block is flush with an end surface of the lock cylinder to form a rotation space on one side of the restricting surface.

6. The lock structure according to claim 4, wherein the coupling section comprises a restricting block; a restricting hole is defined on the restricting plate, and the restricting plate is positioned on the coupling section by being mounted on the restricting block via the restricting hole.

7. The lock structure according to claim 1, further comprising a nut, wherein the coupling section comprises a plurality of first threads, and the latch tongue is fixed to the coupling section by being threadedly engaged with the first threads via the nut.

8. The lock structure according to claim 1, wherein the positioning block comprises a plurality of second threads on a periphery thereof; the lock cylinder comprises a plurality of internal threads on an inner wall surface thereof; and the positioning block is secured within the lock cylinder by threaded engagement between the second threads and the internal threads.

9. The lock structure according to claim 1, wherein a through hole is defined on the positioning block, and the positioning block is mounted on the connecting section via the through hole.

10. The lock structure according to claim 1, wherein a plurality of latching grooves is defined on the positioning block.
